(19) United States
(12) Patent Application Publication
(10) Pub. No.: US 2018/0040129 A1
(43) Pub. Date: Feb. 8, 2018

(54) TRAILER ARTICULATION CALCULATING SYSTEM AND METHOD FOR CALCULATING ARTICULATION ANGLE OF TRAILER

(71) Applicant: DENSO International America, Inc., Southfield, MI (US)

(72) Inventor: Kevin DOTZLER, Poway, CA (US)

(21) Appl. No.: 15/226,262

(22) Filed: Aug. 2, 2016

(51) Int. Cl. G06T 7/00; B60R 11/04; G06K 7/14; G06K 9/32; G06K 9/00; G06K 7/10; B60R 1/00; G06K 9/62

(52) U.S. Cl. CPC G06T 7/0044; B60R 1/002; B60R 11/04; G06K 9/6202; G06K 9/3233; G06K 9/00791; G06K 7/10722; G06K 7/1417; G06T 2207/30204; G06T 2207/30252

(57) ABSTRACT

The present disclosure provides a trailer articulation calculating system. The system includes a two-dimensional barcode, a camera, and an articulation calculator. The two-dimensional barcode is disposed in a front side of a trailer. The camera is disposed in a rear side of a tractor. The camera captures image data of the two-dimensional barcode. The articulation calculator calculates an articulation angle of the trailer relative to the tractor based on the image data captured by the camera.

### FIELD

The present disclosure relates to a trailer articulation calculating system and a method for calculating an articulation angle of a trailer.

### BACKGROUND

This section provides background information related to the present disclosure which is not necessarily prior art.

The trucking industry has utilized a plurality of tractors and trailers in combinations according to transporting plans. There are variety of types of trailers in their sizes and usages, and even each trailer changes its weight, its destination, and so on, depending on loads in the trailer. Such information may be shared with surrounding vehicles through, e.g., a DSRC network.

An articulating vehicle such as a tractor-trailer dynamically changes its articulation when right/left-turning, curving, lane-changing, or the like. Therefore, for DSRC communications, an articulation angle of an articulating vehicle would be necessarily detected on a real-time basis to obtain complete dimensional information.

### SUMMARY

This section provides a general summary of the disclosure, and is not a comprehensive disclosure of its full scope or all of its features. The present disclosure provides a trailer articulation calculating system.

The system includes a fiducial object, a camera, and an articulation calculator. The fiducial object is disposed in a front side of a trailer. The camera is disposed in a rear side of a tractor. The camera captures image data of the fiducial object. The articulation calculator calculates an articulation angle of the trailer relative to the tractor based on the image data captured by the camera.

The present disclosure further provides a method for calculating an articulation angle of a trailer. The method includes capturing, by camera, image data of a fiducial object disposed in a front side of the trailer, and calculating the articulation angle based on the image data.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a high level system diagram of a trailer articulation calculating system according to a first embodiment;

FIG. 2 is a top view of a tractor and a trailer that is in a default orientation;

FIG. 3 is a top view of the tractor and the trailer that is rotated relative to the tractor;

FIG. 4 is a side view of the tractor and the trailer that is connected to the tractor;

FIG. 5 is a block diagram of an angle calculation unit;

FIG. 6 is a side view of the tractor and the trailer when the tractor is being connected to the trailer;

FIG. 7 is a flowchart for an assist control by a microprocessor;

FIG. 8 is a flowchart for an articulation calculation control by the microprocessor;

FIG. 9 is a top view of a tractor and a trailer that is in a default orientation according to a third embodiment; and

FIG. 10 is a top view of the tractor and the trailer that is rotated relative to the tractor according to the third embodiment.

### DETAILED DESCRIPTION

A plurality of embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts may be combined. The embodiments may be partially combined even if it is not explicitly described that the embodiments may be combined, provided there is no harm in the combination.

### First Embodiment

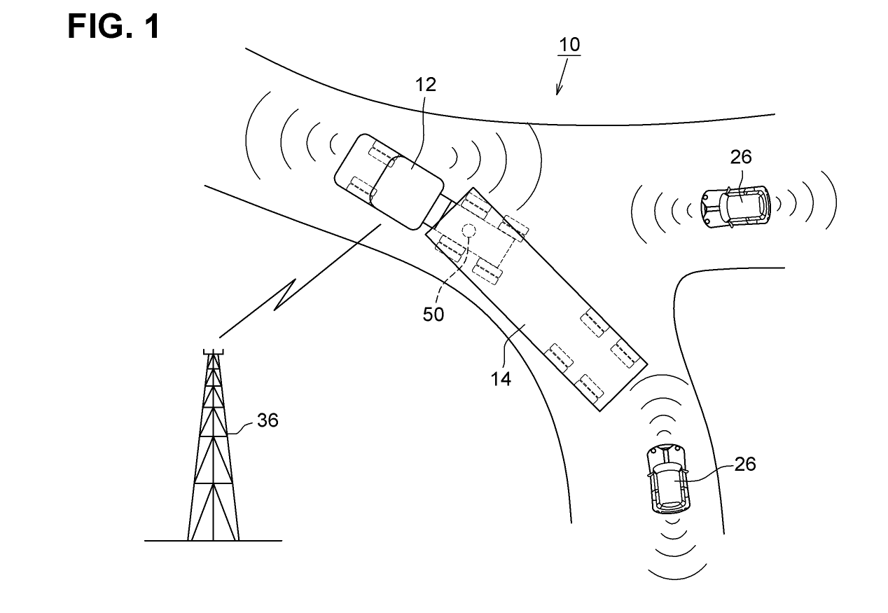

FIG. 1 depicts a high level system diagram of a trailer articulation calculating system 10 and a method for calculating an articulation angle θ of a trailer according to the present embodiment. FIG. 1 shows a tractor 12 is towing a trailer 14 and is entering into a main road at a T junction by turning left. The trailer 14 has loads (not shown) loaded therein. The trailer articulation calculating system 10 dynamically calculates and outputs an articulation angle θ of the trailer 14 relative to the tractor 12 on a real-time basis, as will be described below.

The trailer articulation calculating system 10 generally includes a two-dimensional (2D) barcode 16 as a fiducial object, a camera 18, and a microprocessor 20 as an articulation calculator and a distance calculator.

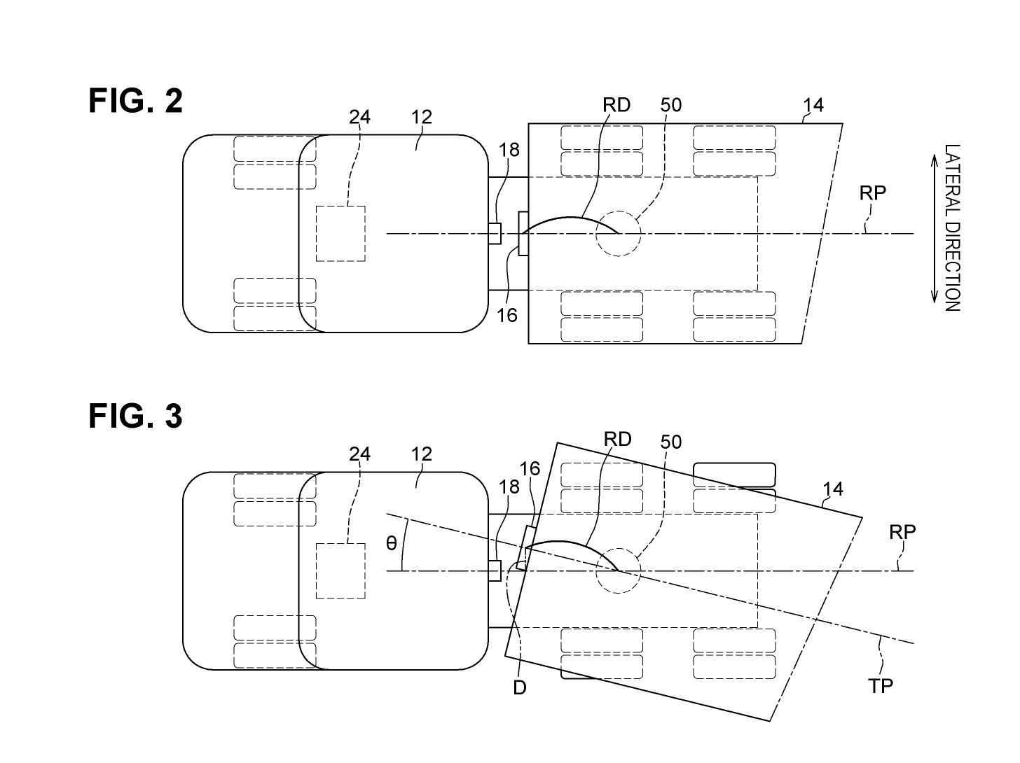

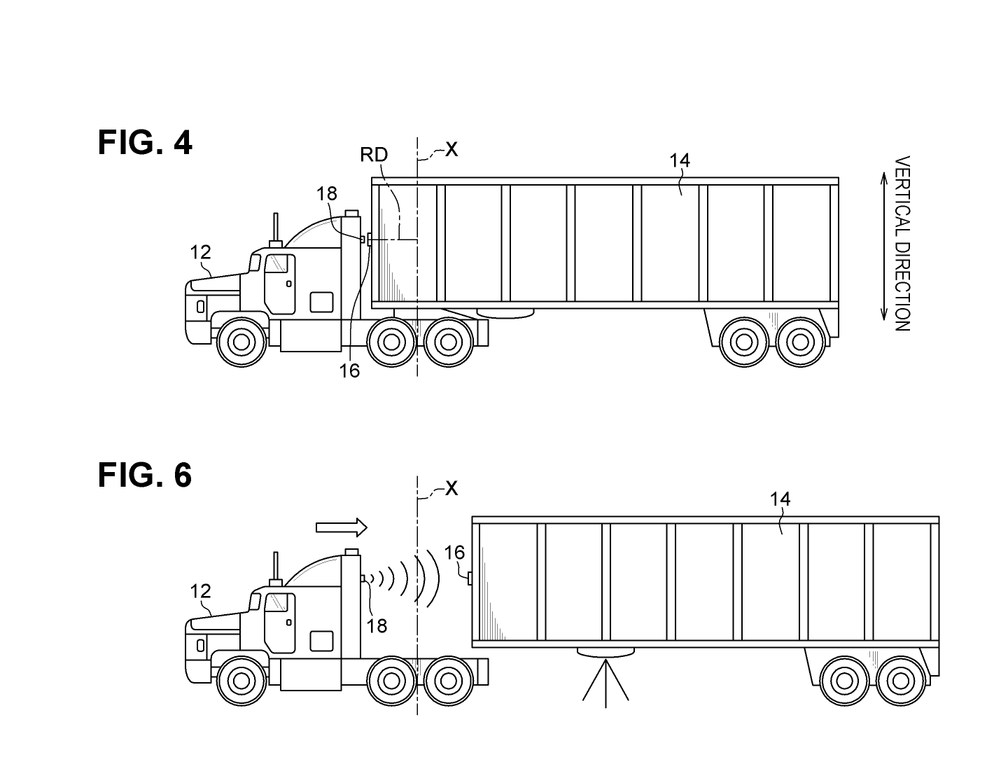

The trailer 14 has a rectangular parallelepiped shape and is connected to the tractor 12 through a kingpin 50. It is understood that the trailer connection is not strictly limited to a kingpin 50, and it could be a heavy-duty hitch as well. For example on a dual tandem trailer rig, the ^{s}second trailer is pulled by the first trailer by a hitch. The trailer 14 is rotatable relative to the tractor 12 about the kingpin 50 as shown in FIGS. 2 and 3. The two-dimensional barcode 16 such as a QR code (a registered trademark) is attached to a front surface (front side) of the trailer 14 such that the two-dimensional barcode 16 can be scanned on the front surface. As shown in FIGS. 2 and 4, the two-dimensional barcode 16 is positioned around the center of the front surface of the trailer 14. More detail, the two-dimensional barcode 16 is at the center of both the width and the height of the trailer 14. However, the position of the two-dimensional barcode 16 is not limited to the center of the surface of the trailer 14. For example, the two-dimensional barcode 16 may be positioned at a very lower side of the surface of the trailer 14.

The two-dimensional barcode 16 stores (i.e., encodes) identification data associated with the trailer 14 and the loads in the trailer 14. The identification data includes, for example, an ID number of the trailer 14, information of the loads, gross weight of the trailer 14 including the loads, a dimension of the trailer 14 (i.e., width, length, and height of the trailer 14), a destination of the trailer 14, a VIN (Vehicle Identification Number), a manufacturer of the trailer 14, a model of the trailer 14, an owner serialization, and other unique identifying information as to the trailer 14 or the loads. In the present embodiment, the identification data further includes a default size of the two-dimensional barcode 16. The default size is defined as a size (or a shape) of the two-dimensional barcode 16.

The camera 18 is a vehicle mounted camera and is disposed in a rear side of the tractor 12 to face backward. The camera 18 serves as a barcode reader to scan the two-dimensional barcode 16. The camera 18 also serves as a digital camera to capture image data of the two-dimensional barcode 16. The camera 18 is positioned on the rear side of the tractor 12 such that the camera 18 faces (i.e., aligned with) the two-dimensional barcode 16 when the trailer 14 is not angled relative to the tractor 12 (see FIG. 2). In other words, when the trailer 14 is not angled relative to the tractor 12, the position of the camera 18 in a vertical direction in gravity (see FIG. 4) and a lateral direction along the width of the trailer 14 (see FIG. 2) is substantially the same as the two-dimensional barcode 16.

Here, an imaginary referential plane RP is defined as an imaginary plane on which the camera 18 and the kingpin 50 are positioned. When the trailer 14 is not angled relative to the trailer 12, the two-dimensional barcode 16 is also positioned on the imaginary referential plane RP as shown in FIG. 2. That is, when the trailer 14 is not rotated, the camera 18, the two-dimensional barcode 16, and the kingpin 50 are aligned with each other along a straight line. An imaginary trailer plane TP is defined as an imaginary plane on which the kingpin 50 and the two-dimensional barcode 16 are positioned (see FIG. 3). In this disclosure, an articulation angle θ is defined as an angle between the imaginary referential plane RP and the imaginary trailer plane TP. It should be understood that the imaginary referential plane RP and the imaginary trailer plane TP are overlapped each other (i.e., the articulation angle θ is zero) when the trailer 14 is not angled relative to the tractor 12. Hereinafter, the orientation of the trailer 14 where the trailer 14 is not angled relative to the tractor 12 is referred to as a “default orientation”.

When the trailer 14 is angled relative to the tractor 12, a minimum distance between the two-dimensional barcode 16 and an axis X (see FIG. 4) of the kingpin 50 is defined as a referential distance RD. In the present embodiment, the information of the referential distance RD is stored (i.e., encoded) in the two-dimensional barcode 16 as the identification data of the trailer 14.

The camera 18 is configured to automatically scan and capture the two-dimensional barcode 16 when the two-dimensional barcode 16 comes into a specified readable range of the camera 18. The camera 18 is connected to an angle calculation unit 24 in the tractor 12, more specifically connected to the microprocessor 20 in the angle calculation unit 24, through Ethernet, for example. The camera 18 transmits the image data and the identification data retrieved from the two-dimensional barcode 16 to the microprocessor 20 though the Ethernet.

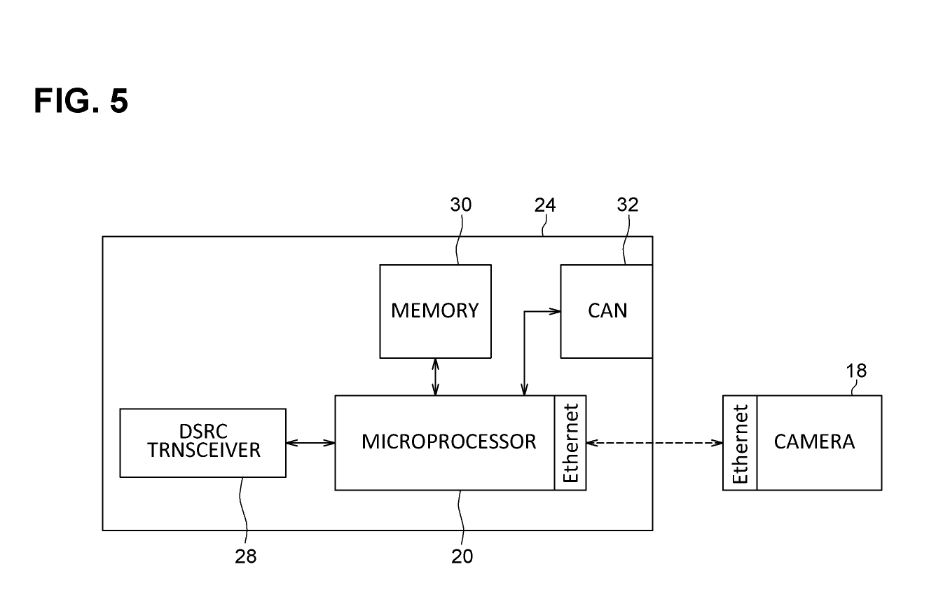

The angle calculation unit 24 is configured to form a V2X (Vehicle-to-everything) subsystem for the trailer articulation calculating system 10. As shown in FIG. 5, the angle calculation unit 24 includes the microprocessor 20, a DSRC (Dedicated Short-Range Communications) transceiver, a memory 30, and, a CAN (Controller Area Network) bus 32. The microprocessor 20 is connected to all other components 28, 30, 32 in the angle calculation unit 24.

The DSRC transceiver 28 is configured to wirelessly communicate with surrounding vehicles 26 through DSRC network such as DSRC RSEs (Road Side Equipment) 36. The DSRC transceiver 28 receives information, such as traffic information, safety warnings, identity information of the surrounding vehicles 26, or the like. The DSRC transceiver 28 is also connected to the microprocessor 20. The DSRC transceiver 28 receives information including the identity information and the articulation angle θ calculated by the microprocessor 20 and transmits such information to surrounding vehicles 26 through the DSRC network (the DSRC RSE 36). Although, in this present embodiment, the communication between the tractor 12 and the surrounding vehicles 26 are conducted through the DSRC network, the communication may be performed through other a V2X network system.

The memory 30 is a form of computer data storage and includes a ROM and a RAM. The memory 30 stores programs executed by the microprocessor 20. Furthermore, the memory 30 tentatively stores the default size of the two-dimensional barcode 16 and the referential distance RD retrieved by the camera 18.

The CAN bus 32 is connected to both an electronic control unit (ECU, not illustrated) for controlling an engine of the tractor 12 and the microprocessor 20. The ECU and the microprocessor 20 are allowed to communicate with each other through the CAN bus 32. The ECU sends operating condition of the engine to the microprocessor 20, whereas the microprocessor 20 sends controlling signals to the ECU. The CAN bus 32 is also connected to a display controller that controls a display (not shown) in an interior of the tractor 12.

In the present embodiment, the microprocessor 20 provides an assist control to assist a driver of the tractor 12 when connecting the tractor 12 to the trailer 14 and an articulation calculation control to calculate the articulation angle θ of the trailer 14. The microprocessor 20 performs these controls by executing the programs stored in the memory 30, as will be described below. In addition, the microprocessor 20 also controls operation of the engine according to traffic conditions and operational information of the surrounding vehicles 26 obtained from the DSRC transceiver 28. The microprocessor 20 generates and sends controlling signals to the ECU through the CAN bus 32 to control the engine of the tractor 12.

The microprocessor 20 is programmed to execute the assist control when a driver is connecting the tractor 12 to the trailer 14 (see FIG. 6). The microprocessor 20 assists the driver by displaying the distance to the trailer 14 from the tractor 12 (i.e., the camera 18) on the display. The microprocessor 20 calculates the distance to the trailer 14 based on the image data captured by the camera 18. More specifically, the microprocessor 20 obtains a current size of the two-dimensional barcode 16 based on the image data currently captured by the camera 18. Then the microprocessor 20 calculates the distance to the trailer 14 by comparing the current size of the two-dimensional barcode 16 to the default size stored in the memory 30. The microprocessor 20 outputs the distance to the trailer 14 to the display controller, and then the display controller controls the display to notify the driver of the distance to the trailer 14.

The microprocessor 20 performs the articulation calculation control when the tractor 12 is in operation. The microprocessor 20 calculates the articulation angle θ of the trailer 14 based on the image data of the two-dimensional barcode 16 captured by the camera 18. More specifically, the microprocessor 20 obtains a deviation D of the two-dimensional barcode 16 from the image data. The deviation D is defined as a minimum distance between the two-dimensional barcode 16 and the imaginary referential plane RP as shown in FIG. 3. Then the microprocessor 20 calculates the articulation angle θ based on the deviation D currently obtained and the referential distance RD using, e.g., a trigonometric function. The microprocessor 20 outputs the articulation angle θ to the DSRC transceiver 28 and then the articulation angle θ is sent to the surrounding vehicles 26 from the DSRC transceiver 28 through the DSRC network.

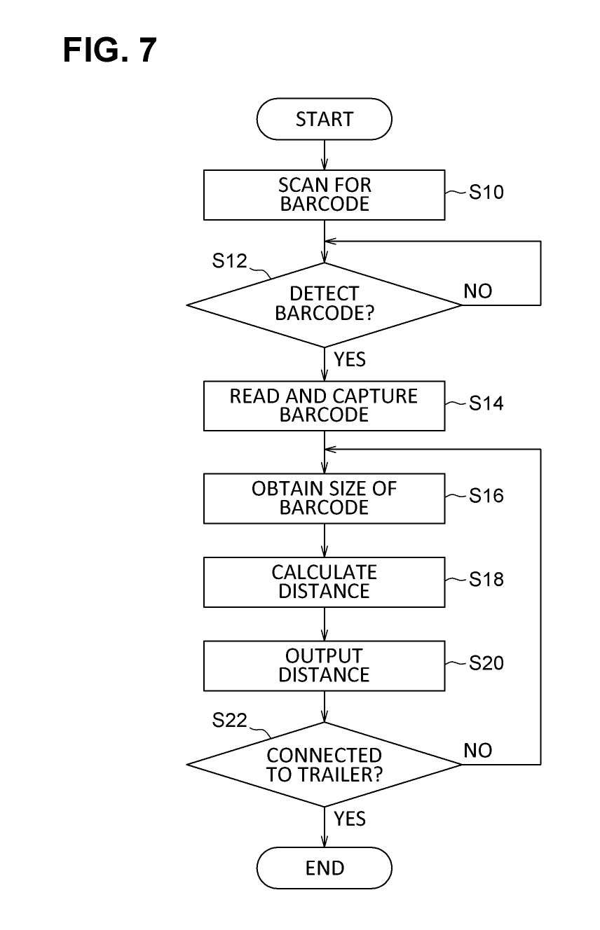

Next, operation of the trailer articulation calculating system 10 and the method for the articulation angle θ will be described below. When connecting the tractor 12 to the trailer 14, the system 10 executes the assist control according to the flowchart of FIG. 7. When the microprocessor 20 detects driver's intention to connect the tractor 12 to the trailer 14 (by detecting, e.g., a reverse gear signal), the camera 18 starts scanning for the two-dimensional barcode 16 at Step 10. When the two-dimensional barcode 16 comes into a readable range (Step 12: Yes), the camera 18 automatically reads the two-dimensional barcode 16 and retrieves the identification data of the trailer 14 including the default size of the two-dimensional barcode 16 and the referential distance RD (Step 14). The default size and the referential distance RD are stored in the memory 30 through the CAN bus 32.

Next, the microprocessor 20 obtains the current size of the two-dimensional barcode 16 from the image data currently captured by the camera 18 at Step 16. Then, the microprocessor 20 calculates the distance to the trailer 14 by comparing the current size of the two-dimensional barcode 16 to the default size stored in the memory 30 at Step 18. Next, the microprocessor 20 outputs the distance to the display through the CAN bus 32, and then the driver is informed of the distance to the trailer 14 on the display.

The processes of Steps 16 to 20 are repeated until the tractor 12 is connected to the trailer 14. When the tractor 12 is connected to the trailer 14 (Step 22: YES), the microprocessor 20 terminates the assist control. As described above, since the driver is notified of the distance to the trailer 14, the driver can safely connect the tractor 12 to the trailer 14.

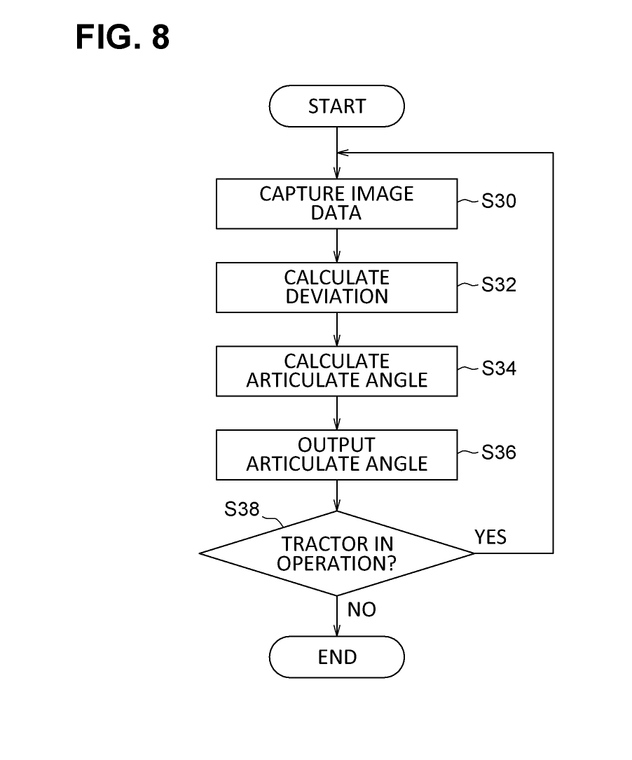

During operation of the tractor 12 towing the trailer 14, the microprocessor 20 executes the articulation calculation control according to the flowchart of FIG. 8. It should be noted that the referential distance RD has been already retrieved and stored in the memory 30 at Step 14 of FIG. 7. When the tractor 12 is in operation, the camera 18 captures the image data of the two-dimensional barcode 16 as Step 30. Then, the microprocessor 20 calculates the deviation D of the two-dimensional barcode 16 at Step based on the image data captured at Step 30. Next, the microprocessor 20 calculates the articulation angle θ based on the deviation D with the referential distance RD stored in the memory 30 at Step 34. Then, the microcomputer outputs the articulation angle θ of the trailer 14 to the DSRC network (the DSRC RSE 36) through the DSRC transceiver 28 at Step 36. The articulation angle θ output from the tractor 12 is shared with surrounding vehicles 26. In this way, the calculation of the articulation angle θ according to Steps 30 to 36 is repeated while the tractor 12 is in operation. When the tractor 12 stops operation (Step 38: NO), the microprocessor 20 terminates the articulation calculation control.

As described above, the system 10 can dynamically calculate and output the articulation angle θ of the trailer 14. Therefore, the surrounding vehicles 26 can obtain the articulation angle θ of the trailer 14 relative to the tractor 12 on a real-time basis. Thus, even if the tractor 12 is turning at a T junction as described in FIG. 1, the surrounding vehicles 26 can obtain information of complete dimensional data of the tractor-trailer.

### Second Embodiment

In the first embodiment, the microprocessor 20 calculates the articulation angle θ based on the deviation D of the two-dimensional barcode 16. Alternatively, the microprocessor 20 may calculate the articulation angle θ based on other elements relating to the two-dimensional barcode 16. For example, the microprocessor 20 may calculate the articulation angle θ based on an aspect ratio of the two-dimensional barcode 16. The aspect ratio of the two-dimensional barcode 16 viewed from the camera 18 varies as the trailer 14 rotates relative to the tractor 12. Therefore, the articulation angle θ can be calculated based on the change in the aspect ratio of the two-dimensional barcode 16.

For example, the two-dimensional barcode 16 may encode a default aspect ratio of the trailer 14. The default aspect ratio is an aspect ratio determined based on the default size of the two-dimensional barcode 16. The default aspect ratio is retrieved by the camera, and then is stored in the memory 30. During operation of the tractor 12, the microprocessor 20 obtains an aspect ratio (hereinafter referred to as a “current aspect ratio”) of the two-dimensional barcode 16 from the image data currently captured by the camera 18. Then, the microprocessor 20 calculates the articulation angle θ by comparing the current aspect ratio to the default aspect ratio stored in the memory 30. For example, the microprocessor 20 may calculate the articulation angle θ using a map representing a relationship between the default aspect ratio and the current aspect ratio. Such a map may be prepared in advance through experimentations. Alternatively, the articulation angle θ may be calculated using an equation with the current aspect ratio and the default aspect ratio.

### Third Embodiment

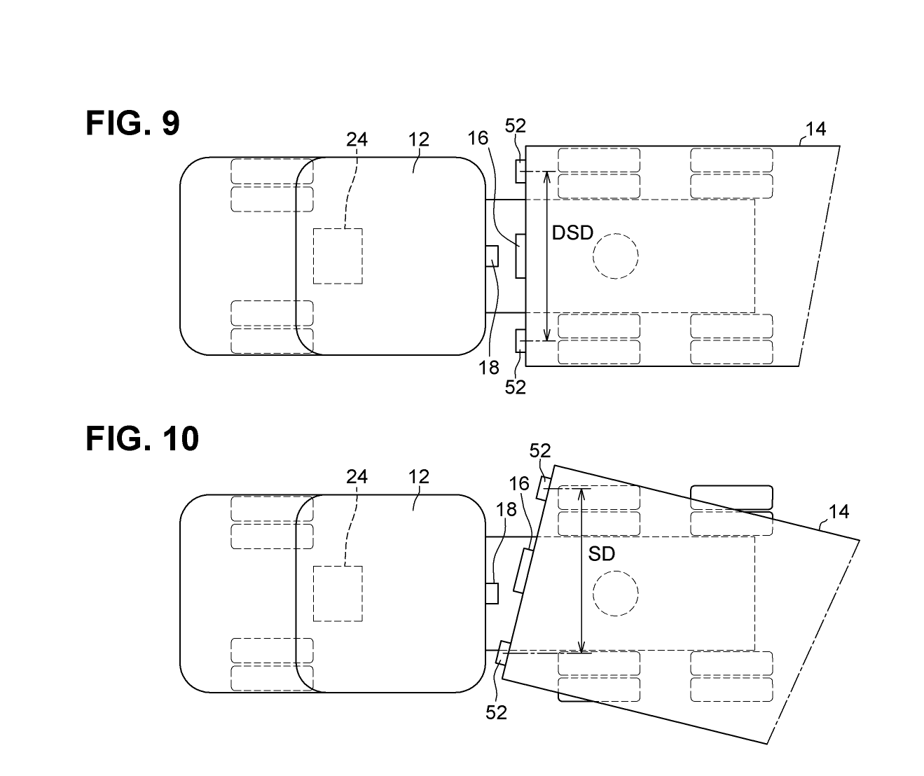

In the first and second embodiments, the microprocessor 20 calculates the articulation angle θ based on information relating to the two-dimensional barcode 16. In the third embodiment, two rivets 52 among a plurality of rivets 52 disposed in the front surface of the trailer 14 are used as the fiducial object (two fiducial elements). The two rivets 52 are positioned at the same level in height of the trailer 14. In the present embodiment, the distance of the two rivets 52 viewed from the camera 18 when the trailer 14 is in the default orientation is defined as a default space distance DSD (see FIG. 9). As shown in the FIG. 10, when the trailer 14 rotates relative to the tractor 12, a distance between the two rivets 52 viewed from the camera 18 (hereinafter referred to as a “space distance SD”) is shorter than the default space distance DSD. In other words, the space distance SD between the two rivets 52 viewed from the camera 18 varies as the trailer 14 rotates relative to the tractor 12. Hence, in the third embodiment, the microprocessor 20 calculates the articulation angle θ based the change in the space distance SD between the two rivets 52.

For example, the two-dimensional barcode 16 encodes the default space distance DSD of the two rivets 52. The default space distance DSD is retrieved by the camera 18 when the trailer 14 is connected to the tractor 12, and then is stored in the memory 30. During operation of the tractor 12, the microprocessor 20 obtains the space distance SD of the two rivets 52 from the image data captured by the camera 18. Then, the microprocessor 20 calculates the articulation angle θ by comparing the space distance SD currently obtained to the default space distance DSD stored in the memory 30. For example, the microprocessor 20 may calculate the articulation angle θ using a map representing a relationship between the space distance SD and the default space distance DSD. Such a map is prepared in advance through experimentations. Alternatively, the articulation angle θ may be calculated using an equation with the space distance SD and the default space distance DSD. It should be understood that two brackets disposed in the front surface of the trailer 14 may be used as the fiducial object (the fiducial elements) in place of the rivets 52.

### Other Embodiments

In the first embodiment, the microprocessor 20 executes the assist control and the articulation calculation control. In other words, the microprocessor 20 serves as an articulation calculator and a distance calculator. However, the microprocessor 20 only executes the articulation calculation control and the assist control may be eliminated.

In the first embodiment, the two-dimensional barcode 16 is used as the fiducial object in addition to a function as a barcode to store information of the trailer 14. However, another configuration may be applied to the fiducial object other than the two-dimensional barcode. For example, an additional component may be disposed to the front side of the trailer 14 as the fiducial object without using the two-dimensional barcode 16.

In the first embodiment, the assist control provides showing of the distance to the trailer 14 to a driver. In addition, the assist control may provide left-right alignment and/or angular alignment information to the driver during trailer connection. For example, alignment information while backing the tractor 12 toward the trailer may be displayed to the driver 14 in addition to distance information.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

What is claimed is:

1. A trailer articulation calculating system comprising:
a fiducial object that is disposed in a front side of a trailer;
a camera that is disposed in a rear side of a tractor, the camera capturing image data of the fiducial object; and
an articulation calculator that calculates an articulation angle of the trailer relative to the tractor based on the image data captured by the camera.

2. The trailer articulation calculating system according to claim 1, wherein
the trailer is connected to the tractor through a kingpin and is configured to be rotatable relative to the tractor about the kingpin,
the kingpin and the camera are positioned on an imaginary referential plane,
the fiducial object is on the imaginary referential plane when the trailer is in a default orientation where the articulation angle is zero, and
the articulation calculator calculates the articulation angle based on a deviation of the fiducial object from the imaginary referential plane.

3. The trailer articulation calculating system according to claim 1, wherein
the fiducial object has a default aspect ratio when the trailer is in a default orientation where the articulation angle is zero, and
the articulation calculator calculates the articulation angle by comparing an aspect ratio of the fiducial object captured by the camera to the default aspect ratio.

4. The trailer articulation calculating system according to claim 1, wherein
the fiducial object includes two fiducial elements,
the two fiducial elements have a default space distance therebetween viewed from the camera when the trailer is in a default orientation where the articulation angle is zero, and
the articulation calculator calculates the articulation angle by comparing a distance between the two fiducial elements viewed from the camera to the default space distance.

5. The trailer articulation calculating system according to claim 1, further comprising
a DSRC transceiver that transmits the articulation angle calculated by the articulation calculator to a surrounding vehicle through a DSRC network.

6. The trailer articulation calculating system according to claim 1, wherein
the fiducial object is a two-dimensional barcode.

7. The trailer articulation calculating system according to claim 4, wherein
the two fiducial elements are rivets or brackets disposed on the front side of the trailer.

8. The trailer articulation calculating system according to claim 1, further comprising
a distance calculator that calculates, when the tractor is connected to the trailer, a distance to the trailer from the tractor based on the image data of the fiducial object captured by the camera.

9. The trailer articulation calculating system according to claim 8, wherein
the fiducial object has a default size when the trailer is in a default orientation where the articulation angle is zero, and
the distance calculator calculates the distance to the trailer by comparing a size of the fiducial object captured by the camera to the default size.

10. A method for calculating an articulation angle of a trailer, the method comprising:
capturing, by camera, image data of a fiducial object disposed in a front side of the trailer; and
calculating the articulation angle based on the image data.

11. The method according to claim 10, wherein
an imaginary referential plane is defined as a plane on which the camera and a kingpin, through which the trailer is connected to the tractor, are positioned,
the fiducial object is on the imaginary referential plane when the trailer is in a default orientation where the articulation angle is zero, and
the articulation angle is calculated based on a deviation of the fiducial object from the imaginary referential plane.

12. The method according to claim 10, wherein
the fiducial object has a default aspect ratio when the trailer is in a default orientation where the articulation angle is zero, and
the articulation angle is calculated by comparing an aspect ratio of the fiducial object captured by the camera to the default aspect ratio.

13. The method according to claim 10, wherein
the fiducial object includes two fiducial elements,
the two fiducial elements have a default space distance therebetween viewed from the camera when the trailer is in a default orientation where the articulation angle is zero, and
the articulation angle is calculated by comparing a distance between the two fiducial elements viewed from the camera to the default space distance.

14. The method according to claim 10, further comprising
transmitting the articulation angle to a surrounding vehicle through a DSRC network.

15. The method according to claim 10, further comprising
calculating, when the tractor is connected to the trailer, a distance to the trailer from the tractor based on the image data of the fiducial object captured by the camera.

16. The method according to claim 15, wherein
the fiducial object has a default size when the trailer is in a default orientation where the articulation angle is zero, and
the distance to the trailer is calculated by comparing a size of the fiducial object captured by the camera to the default size.
